(19) United States
(12) Patent Application Publication
(10) Pub. No.: US 2008/0115640 A1
(43) Pub. Date: May 22, 2008

(54) Apparatus For Processing A Specimen

(75) Inventor: Robert Ranner, Vienna (AT)

Correspondence Address: HODGSON RUSS LLP;THE GUARANTY BUILDING, 140 PEARL STREET, SUITE 100, BUFFALO, NY, 14202-4040, US

(73) Assignee: LEICA MIKROSYSTEME GMBH, Vienna (AT)

(21) Appl. No.: 11/940,430

(22) Filed: Nov. 15, 2007

(30) Foreign Application Priority Data
Nov. 17, 2006 (DE) 10 2006 054 617.2

(51) Int. Cl. B26D 7/08; B26D 1/12

(52) U.S. Cl. 83/98; 407/33

(57) ABSTRACT

An apparatus (1) for processing specimens (15), comprises an observation device (2) for observing a specimen (15), a specimen holder (3) for receiving the specimen (15) to be processed, and a tool holder (6), which is suitable for the reception of tools (5) for different processing steps.

### CROSS-REFERENCE TO RELATED APPLICATIONS

This application claims priority of the German patent application no. 10 2006 054 617.2 filed Nov. 17, 2006, which is incorporated by reference herein.

### FIELD OF THE INVENTION

The present invention relates to an apparatus for processing specimens, having an observation device for observing a specimen, a specimen holder for receiving the specimen to be processed, and a tool holder.

### BACKGROUND OF THE INVENTION

Apparatuses of this kind are manufactured for the preparation of specimens, in particular for the production of microtome sections. For this, tissue specimens to be examined are, for example, embedded in synthetic resin and these specimens are processed by means of milling cutters into the shape of truncated pyramids. These trimmed specimens are then sectioned in a microtome, thereby yielding tissue sections having a thickness in the micrometer or nanometer range that can then be examined.

The assignee of the present application has developed a unit that is suitable for such tasks and is already on the market. This unit additionally comprises an observation device with which the specimen can also be observed during processing.

These units are not suitable, however, for specimens made of harder material. For example, milling is not a suitable processing method for semiconductor materials such as silicon, gallium arsenide, and the like.

### SUMMARY OF THE INVENTION

It is therefore an object of the invention to create an apparatus of the kind cited initially that is suitable for processing a plurality of different materials.

This object is achieved according to the present invention in that the tool holder of the apparatus is designed to receive tools for different processing steps, and permits a driven rotation of a mounted tool about a longitudinal axis of the tool holder. This makes possible the processing of different materials, in particular of specimens that are made of different materials such as, for example, metals, plastics, and semiconductor materials.

It is particularly advantageous for the processing of such specimens if the tool insertable into the tool holder is a milling cutter, a saw, or a grinding or polishing wheel.

The various tools require different drive speeds adapted to the nature of the particular specimen. In a preferred embodiment of the apparatus according to the present invention, the rotation speed of the tool mounted or clamped in the tool holder is therefore adjustable in a range from 300 to 20,000 revolutions per minute.

The tool holder is advantageously connected to a spindle that drives the rotary motion of the tool holder about its longitudinal axis.

The tools can be exchanged in particularly simple and easy fashion if the tool holder is embodied as a clamping apparatus.

To allow the specimen, in particular its edges, to be accurately viewed (and, if applicable, measured) in the specimen holder, the specimen holder is rotatable about its longitudinal axis. In a preferred embodiment, the specimen holder has a substantially cylindrical or conical shape. A substantial advantage of the apparatus according to the present invention is that the specimen remains in the specimen holder both for measurement, for example in order to ascertain the necessary processing depth, and also during exchanging of the processing tools. As a result, the specimen remains without change in its position with respect to the specimen holder, and reproducible results upon processing of the specimen are guaranteed.

In a preferred embodiment of the invention, the specimen holder is pivotable about a pivot axis. During processing of the specimen, the specimen holder is pivoted into a position in which the longitudinal axes of the sample holder and of the tool holder are arranged substantially parallel to one another. If, in a further variant of the invention, the observation device comprises a measurement device for measuring the specimen, the specimen holder is then pivotable into a position that by preference is located approximately 20° above the processing position, in order to enable accurate measurement of the specimen edge.

In the context of sawing in particular, it is necessary for the tool holder to be pivotable in a plane normal to its longitudinal axis. This advance, usually in micrometer-scale steps, allows the specimen to be sawn through in controlled fashion, thus yielding the desired specimen surface quality.

In order to achieve optimum specimen surface quality, provision can further be made for the apparatus additionally to comprise a pump system and a metering tube that serves to cool and/or lubricate the specimen during processing. Overheating of the tool and/or specimen during processing is thereby avoided.

The apparatus can be used for processing of specimens that are subsequently further processed or sectioned with a microtome or ultramicrotome.

A further advantageous use of the apparatus is for sectioning or initial cutting of specimens for subsequent specimen examination with a microscope. The latter can be embodied, for example, as a light microscope, scanning electron microscope, or atomic force microscope.

### BRIEF DESCRIPTION OF THE DRAWING FIGURES

The invention will be further explained below with reference to a non-limiting exemplifying embodiment with pertinent Figures, in which:

FIG. 1 is an oblique rear view of the apparatus from the upper right;

FIG. 2 is a side view of the apparatus of FIG. 1;

FIG. 3 is a front view of the apparatus of FIG. 1 from the upper left;

FIG. 4 is an enlarged detail view of the apparatus of FIG. 1 in the region of the clamping apparatus and the specimen receptacle, with a milling cutter;

FIG. 5 is a view corresponding to FIG. 3, with a cutoff saw wheel;

FIG. 6 is a view corresponding to FIG. 3, with a polishing wheel;

FIG. 7 is a view corresponding to FIG. 4, with an apparatus for lubrication during the sawing operation; and

FIGS. 8 and 9 are each views of the apparatus according to FIG. 2 with the housing removed, with different cam plate positions.

### DETAILED DESCRIPTION OF THE INVENTION

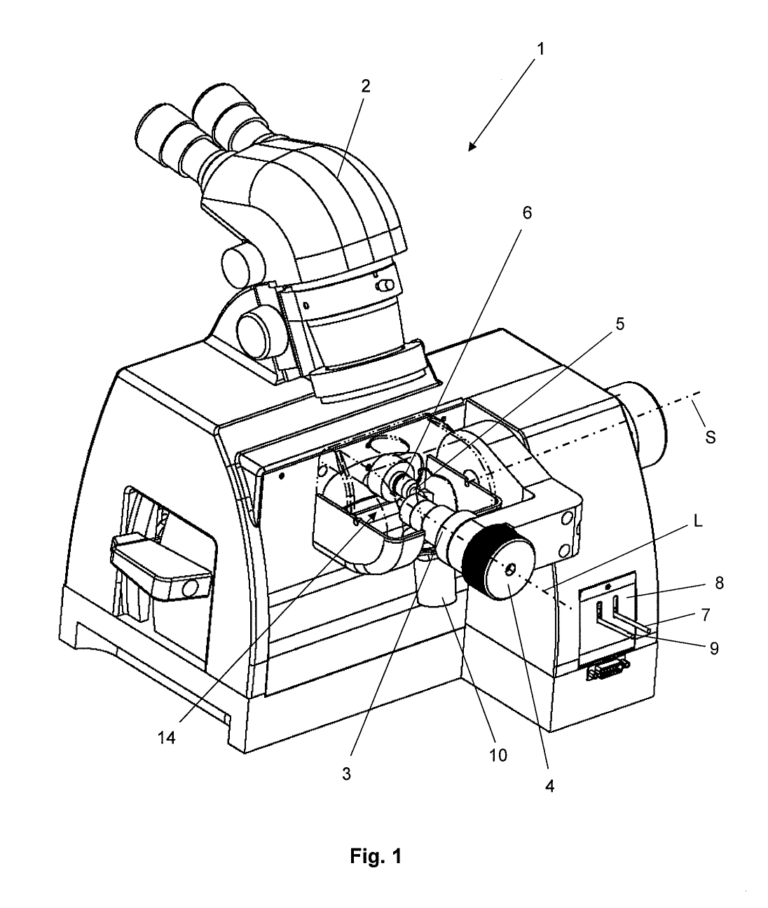

FIG. 1 is a first view of apparatus 1. Apparatus 1 comprises an observation device 2, for example a stereomicroscope, that serves for viewing of a sample to be processed, hereinafter called a “specimen.” A measurement device that enables measurement of the specimen can be provided, if applicable, in the observation device. In a preferred variant of the invention, for example, there is inserted into the stereomicroscope a measuring eyepiece having scale markings with which the specimen itself, but also the manner in which processing is progressing, can be accurately measured. Other systems such as, for example, video cameras and the like can also be used as observation device 2.

Apparatus 1 is equipped with a specimen holder 3 into which the specimen to be processed is inserted. The specimen by preference involves material of high hardness, for example semiconductor materials such as silicon, gallium arsenide, etc. The apparatus is, however, equally suitable for processing biological material that, favorably, is embedded in a synthetic resin.

Specimen holder 3, which is substantially of elongated conical shape, possesses a means for rotating the specimen about longitudinal axis L of specimen holder 3. The specimen can be rotated, by means of a rotary knob 4, in such a way that all regions of the specimen can be viewed through stereomicroscope 2 and/or edges of the specimen can be processed.

Tool 5, for example a milling cutter, is inserted into a tool holder, by preference into a clamping apparatus 6. In a preferred embodiment of the invention, clamping apparatus 6 is driven via a spindle. The rotation speed of the spindle is adjustable, for example, over a range from 300 to 20,000 revolutions per minute. The rotation speed range suitable for processing of the specimen depends on the nature of the specimen material, in particular on its hardness. Rotation speeds of approximately 20,000 rpm, for example, are usually required for milling, whereas for sawing or polishing, rotation speeds of 300-500 rpm often should not be exceeded in order to avoid damage to the specimen and to achieve the desired surface quality.

To allow the specimen to be cooled or lubricated during processing, a system is provided such that a coolant or lubricant is conveyed (from a reservoir that is not depicted) via a first inlet 7 to a pump 8, and is delivered via a second inlet 9 from pump 8 to the specimen. A suction device 10 is furthermore preferably provided in the region of the tool or specimen in order to remove coolant or lubricant, and the material removed during processing, from the specimen surface and from tool 5.

In a preferred variant of the invention, specimen holder 3 is pivotable about a pivot axis S. This pivotability of specimen holder 3 permits the specimen to be brought into a measurement position, a processing position, or an inspection position. FIG. 1 depicts the processing position, in which the longitudinal axes of specimen holder 3 and of clamping apparatus 6 are substantially parallel to one another.

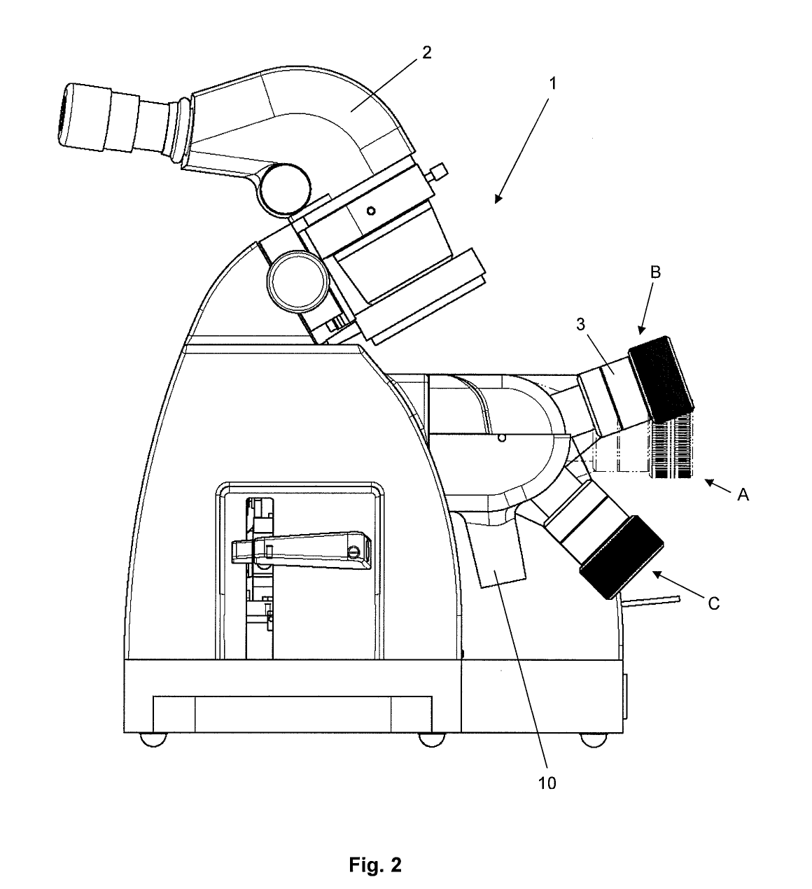

FIG. 2 depicts the three positions of specimen holder 3 that are usually selected. In this depiction, processing position A depicted in FIG. 1 is shown with dot-dash lines. In a measurement position B located approximately 20° above processing position A, accurate measurement of, for example, the specimen edges is possible using suitable measurement apparatuses in observation device 2. If, for example, a phase boundary in a specimen is being exposed by preparation for defect analysis, then firstly, for example, a small region of the specimen is milled down and the material removal required is then determined, for example by means of a measurement device in the eyepiece of microscope 2, by pivoting the specimen into measurement position B. The specimen is then brought back into processing position A by being pivoted, and the specimen is processed in the manner thereby ascertained. Observation of the specimen through microscope 2 during processing is also possible, but with no capability for carrying out accurate measurements.

In a third position (inspection position C), specimen holder 3 is pivoted approximately 45° downward from processing position A. Here the specimen surface is located exactly in the beam path of stereomicroscope 2. In this position C, for example, a check is made as to whether the surface quality of the processed sample is adequate. An analysis of the specimen surface using suitable detectors, for example infrared or fluorescence detectors, is likewise conceivable. Suitable excitation sources in observation device 2 are a prerequisite for this.

Thanks to this observation capability, the progress of specimen processing can be checked at any time during processing with no need to interrupt processing and remove the specimen from specimen holder 3.

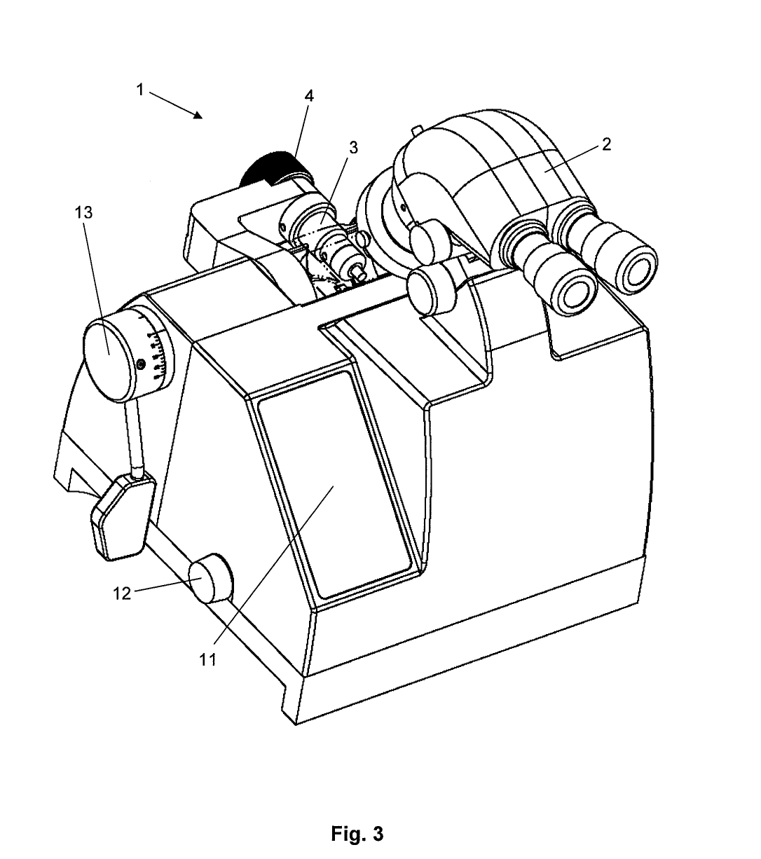

FIG. 3 is a front view of apparatus 1; from this side the user can view the specimen through stereomicroscope 2 and, via an input panel 11 that is embodied e.g. as a keypad with display or as a touch screen, can define all the parameters for processing the specimen, such as the rotation speed of tool 5. In the embodiment of invention as depicted, the advance of tool 5 is set via a rotary knob 12. In another variant of the invention, the advance is likewise defined via input panel 11.

Specimen holder 3 is pivoted via a setting wheel 13 in order to bring the specimen, as already mentioned above, into measurement position B or into the primary processing position A (FIG. 2). The primary processing position A is the position in which the specimen is usually processed, and in which the longitudinal axis of specimen holder 3 and the longitudinal axis of clamping apparatus 6 are aligned parallel with one another. Specimen holder 3 can also be brought into a position located between inspection position B and the primary processing position A. In this case the longitudinal axis of specimen holder 3 is inclined with respect to the longitudinal axis of clamping apparatus 6. It is thus possible to process the edges of the specimen at an angle corresponding to the angle of inclination enclosed by the longitudinal axes of specimen holder 3 and clamping apparatus 6.

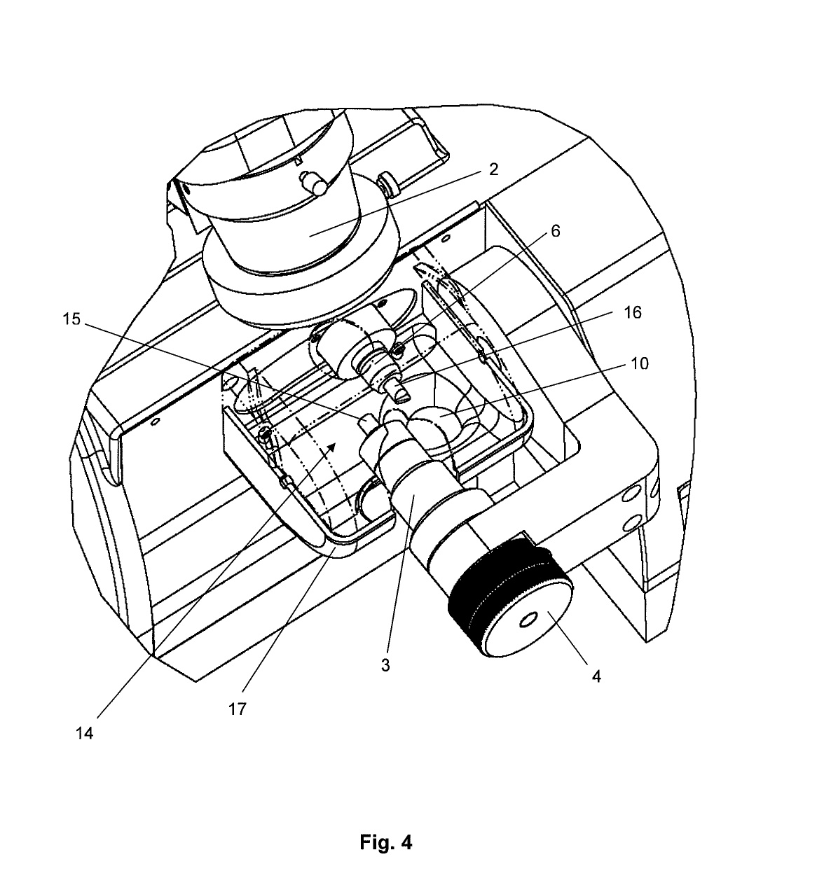

An enlarged view of processing region 14 of apparatus 1 is shown in FIG. 4. A specimen 15 is mounted on specimen holder 3, which is rotatable by means of rotary knob 4. In the instance depicted, a milling cutter 16 is clamped in clamping apparatus 6. In order to avoid contamination of the surrounding area and of apparatus 1 during processing of the specimen, processing region 14 is located in an at least partly transparent housing 17 that comprises a suction opening 10 through which the material removed during processing of specimen 15 is removed. This also avoids any contamination of the optics of stereomicroscope 2, and permits observation of specimen 15 during processing.

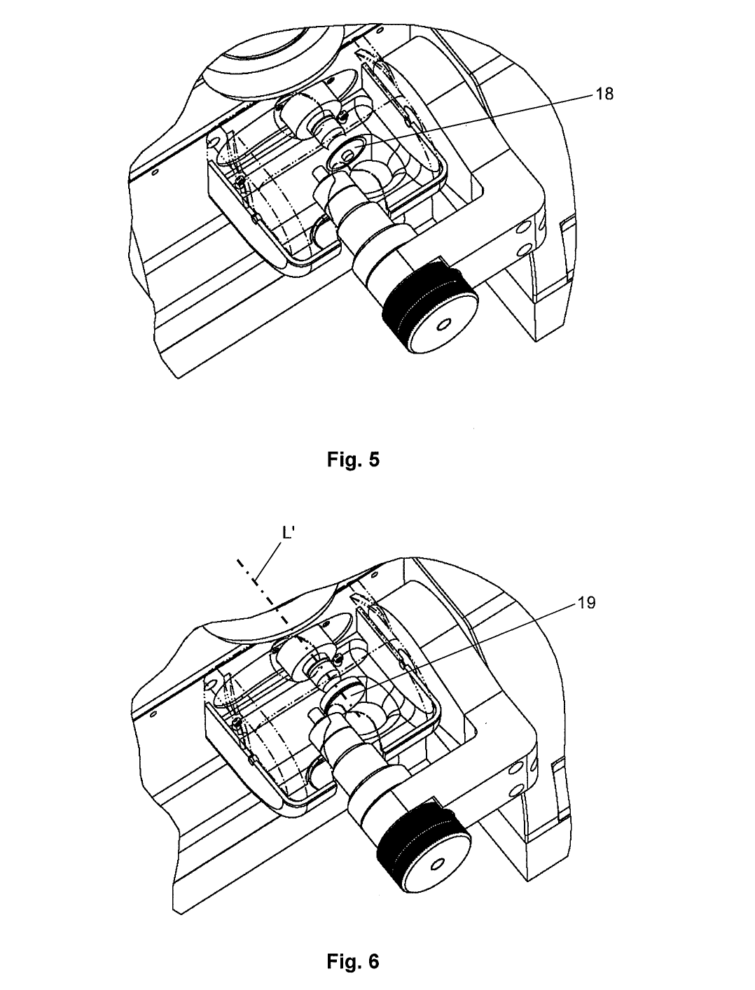

FIG. 5 likewise shows processing region 14 with milling cutter 16 of FIG. 4 having been replaced by a saw wheel 18. This saw wheel is, for example, a diamond saw, making possible the sawing of particularly hard materials such as semiconductor materials.

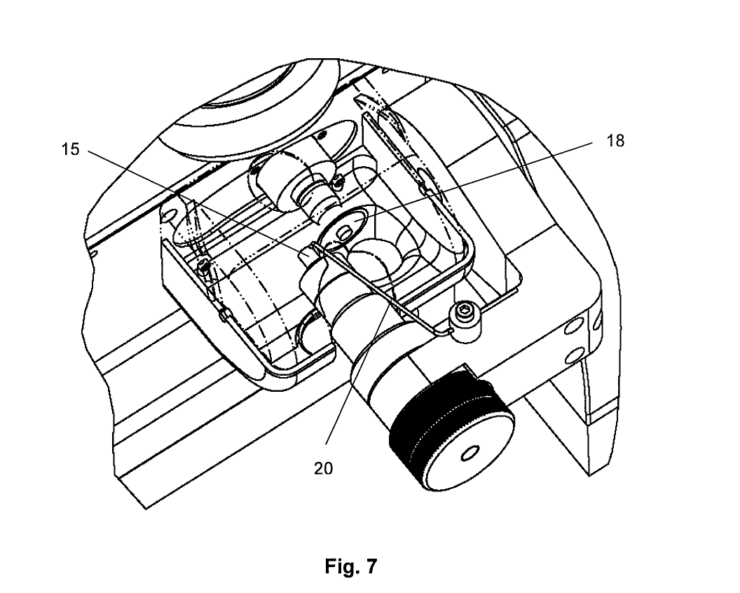

In FIG. 6, instead of saw wheel 18 of FIG. 5, a grinding or polishing wheel 19 is inserted in the clamping apparatus 6.

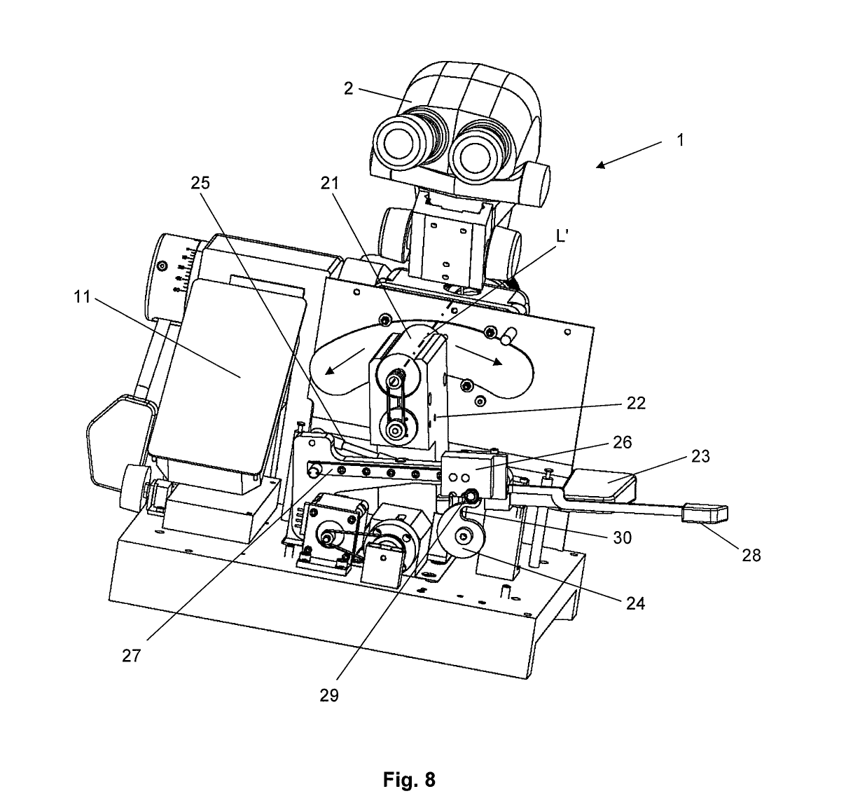

Because higher temperatures occur during processing of the specimen, especially at higher spindle rotation speeds, and can impair the specimen surface or, in the worst case, destroy the specimen, in a preferred embodiment of the invention a system is provided for delivering coolant and/or lubricant. FIG. 7 once again shows processing region 14, saw 18 being secured in clamping apparatus 6. A metering tube 20 that is in communication with inlet 9 of pump 8 of FIG. 1 delivers the coolant or lubricant, which is applied directly onto specimen 15.

A delivery system of this kind can also be necessary in the context of milling or polishing; in the case of polishing of the specimen surface, for example, it is usual to use polishing agent, which is once again applied via metering tube 20 onto the specimen surface.

If, for example, a phase boundary in a semiconductor is to be examined in order to identify defects, specimen 15 is first inserted into specimen holder 3. By means of rotary knob 4, specimen 15 in specimen holder 3 is brought into the position provided for processing. After the insertion of, for example, saw 18, the specimen is first brought, with the aid of the pivotable specimen holder 3, into measurement position B that permits observation of the specimen edge. It is now possible to determine, by means of observation system 2, for example the measurement device in the stereomicroscope, how much material must be removed in order for the desired phase boundary to be exposed. Specimen holder 3 is then pivoted into processing position A, and processing, e.g. sawing, can begin.

A substantial advantage of apparatus 1 according to the present invention is that specimen 15 remains in specimen holder 3 both for measurement, e.g. for determination of the requisite processing depth, and also while the processing tools—such as milling cutter 16, saw 18, or polishing wheel 19—are being exchanged. As a result, specimen 15 remains without change in its position with respect to specimen holder 3, and reproducible results upon processing of specimen 15 are ensured. In contrast thereto, removal of specimen 15—for example for measurement in a separate observation device—and subsequent reinsertion of specimen 15 into specimen holder 3 often results in a discrepancy with regard to the original position of specimen 15 in specimen holder 3, so that a readjustment of specimen 15 in specimen holder 3, with additional effort, must be carried out. Especially when working on the micrometer scale, as in the present example, a shift in the specimen position can cause too much material to be removed, so that the desired phase boundary is missed during preparation. The processing results are therefore not satisfactory because of the positional discrepancy after the removal and reinsertion of specimen 15 into specimen holder 3. The same problem occurs if specimen 15 likewise needs to be removed from specimen holder 3 upon an exchange of tools.

The invention makes removal of the specimen superfluous, and high accuracy and reproducibility are guaranteed.

As specimen 15 is sawn, much of the material covering the phase boundary is removed. In this context, clamping apparatus 6 is moved in a plane normal to the rotation axis of tool holder 6 in accordance with the defined advance, and saw 18 is thereby guided through specimen 15. Depending on the nature of the material of specimen 15, coolant is brought via pump 8 and metering tube 20 to the specimen surface in the region of the saw cut, in order to avoid overheating of specimen 15 and/or of saw 18. During the sawing operation, specimen 15 can be observed at any time through stereomicroscope 2. The material occurring during sawing is continuously drawn off, if applicable together with the coolant or lubricant, in order to reduce contamination of processing space 14 and in particular of specimen 15.

Prior to exchange of the tool, specimen 15 in apparatus 1 according to the present invention can first be pivoted into inspection position C and the surface of specimen 15 can be checked. If no inspection of specimen 15 is necessary, specimen holder 3 remains in processing position A. The tool (in this case saw 18) is then removed from clamping apparatus 6 and replaced with polishing wheel 19, the specimen depth already removed being stored by a control unit of apparatus 1. Spindle 21 is usually displaced in the longitudinal axis in order to change tool 5, since tools 5 usually have different geometries. Polishing wheel 19 is then carefully displaced in longitudinal axis L′ until contact is made against specimen 15, and further processing is then started. The previously sawn surface of specimen 15 is polished with the aid of this tool. The advance necessary during polishing is once again added by the control unit to the value, stored in the control unit, that has already been removed during sawing. The total amount removed from specimen 15 can thus be read out once the processing of specimen 15 is complete. Specimen 15 prepared in this fashion can now be examined, for example, with regard to defects.

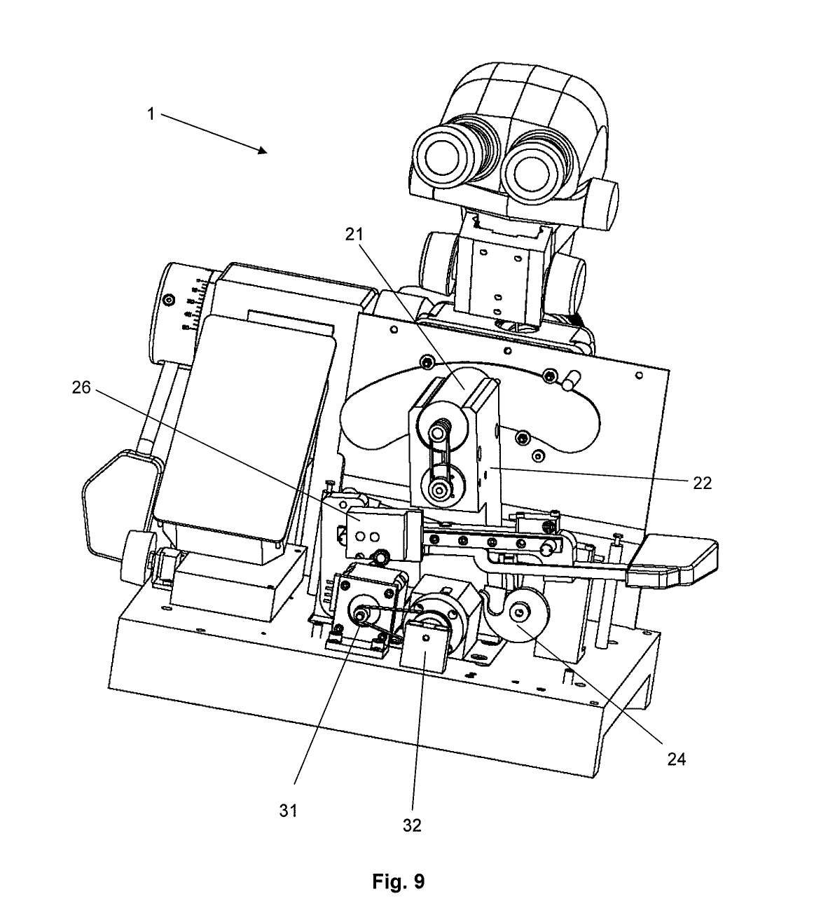

FIGS. 8 and 9 show a front view of apparatus 1 with the housing removed. The rotary motion of clamping apparatus 6 is implemented via a spindle 21. Spindle 21 is connected to a pivot arm 22, pivot arm 22 executing a pivoting motion (indicated by arrows) in a plane extending normal to the rotation axis of spindle 21.

When sawing specimens made of hard material, in particular specimens made of various materials having different hardness values, a uniform, controlled advance of the saw blade is of particular importance. It is useful to apply weights in order to adjust the advance, although this by itself does not yield a uniform advance because, for example, the frictional surface of the saw blade and specimen changes as sawing proceeds in specimens having a round cross section, or the saw resistance changes because of different hardness values of the various materials within the specimen. With very small advance values (<0.05 mm/s), the saw blade often comes to a standstill because of the small applied weight and the differing friction between the saw blade and specimen caused by different materials. With greater applications of weight the different material properties likewise result in irregular cutting speeds, once again negatively affecting the surface quality of the cut. In addition, different cutting speeds can be set only by applying different weights. Another possibility for adjusting the advance or the cutting speed is the use of a positive guidance system. Here as well, problems often occur when the advance is too great or the saw is blunt, and in the worst case these result in breakage of the saw blade and/or of the specimen.

In the apparatus shown, a combination of positive guidance and weight application is implemented in order to establish a uniform cutting speed for saw 18. Pivot arm 22, and therefore the tool in clamping apparatus 6, is movable via lever 23 in a plane normal to longitudinal axis L′ of spindle 21. This pivoting motion of pivot arm 22 defines the cutting speed of saw 18 and, in a preferred embodiment of the invention, is controlled via a stepping motor, the advance being adjustable, in particular, in the micrometer range.

The drive system, for example the stepping motor, is connected to lever 23 via a cam plate 24. Pivot arm 22 in turn is connected to lever 23 via a linkage rod 25 (positive guidance of pivot arm 22). Lever 23 is additionally acted upon by a weight 26, weight 26 resting on a guide 27 that is connected to lever 23. The force applied by weight 26 on lever 23, and therefore on pivot arm 22, changes depending on the location of weight 26. The effect of the weight is greatest when weight 26 is positioned, by movement of a slider 28, on the outer end of guide 27.

Cam plate 24 is in contact with weight 26 via a pin or, as in the embodiment shown, via a ball bearing 29. A ball bearing 29 is particularly suitable because of lower frictional forces. Cam plate 24, connected to the stepping motor, rotates clockwise in the embodiment of apparatus 1 that is shown. Because of the decreasing radius of cam plate 24, the rotation of cam plate 24 produces a lowering of weight 26, and thus of lever 23, at the speed predetermined by the drive system. As a result, pivot arm 22 moves to the right in FIG. 8. When cam plate 24 has performed an almost complete revolution about its own axis, ball bearing 29 travels into an indentation 30 of cam plate 24; the end point of the motion has thus been reached, and specimen 15 has been sawn through. Pivot arm 22 is thereupon pivoted back into its initial position (to the left in FIG. 8).

If saw blade 18 becomes stuck in the specimen, for example, pivot arm 22 thus cannot move further and lever 23 consequently remains in its present position. Cam plate 24 continues to rotate, and because of its decreasing radius loses contact with weight 26. The positive guidance of pivot arm 22 is thereby interrupted, and only weight 26 impinging on pivot arm 22 acts on specimen 15. Destruction of the specimen 15 and/or saw blade 18 by tensile forces resulting from a positive guidance system is thereby avoided. Once the end point of cam plate 24 is reached, pivot arm 22 is pivoted back into its initial position, and the stuck saw 18 is thus pulled out of specimen 15.

In another variant of the invention, the end point is defined not by arrival at the position of cam plate 24 in which ball bearing 29 enters indentation 30, but by stipulating a number of steps of the stepping motor that functions as the drive system. The number of steps can be entered, for example, via input panel 11.

If cam plate 24 is not in contact with weight 26, as shown in FIG. 9, no weight is then acting on pivot arm 22 and the latter is not connected to the drive system of cam plate 24. It therefore remains in the (manually) predetermined position. Tool 5 rotates as a result of the motion of spindle 21, with no advance. This zero-weight setting of pivot arm 22 is selected when apparatus 1 is used for processing a specimen 15 with milling cutter 16 or with grinding or polishing wheel 19.

When specimen 15 is being processed with milling cutter 16, or when grinding and polishing are being performed, it is often desirable for tool 5 to advance in a direction parallel to longitudinal axis L′ of tool holder 6. This motion is generated by a spindle (not shown) in a drive system 31, which spindle acts directly or indirectly via a shaft 32 on pivot arm 22. This advance spindle has, for example, a pitch of 0.5 mm and is driven by a stepping motor at 400 steps per revolution.

In another embodiment (not depicted) of the invention, the positive guidance of pivot arm 22 is implemented by way of a linear guide that is pulled, by means of weight, onto an element that is displaceable at a controlled speed. Provision can also be made for spindle 21 comprising clamping apparatus 6 to be guided along a straight line and not, as shown previously, along a portion of a circular track. Cam plate 24 can moreover be replaced, for example, by a further spindle whose end serves as a support for pivot arm 22.

What is claimed is:

1. An apparatus for processing specimens comprising:
an observation device for observing a specimen;
a specimen holder for receiving the specimen to be processed; and
a tool holder designed to receive tools for different processing steps, wherein the tool holder permits a driven rotation of a received tool about a longitudinal axis of the tool holder.

2. The apparatus according to claim 1, wherein the tool holder is connected to a spindle that drives a rotary motion of the tool holder about its longitudinal axis.

3. The apparatus according to claim 1, wherein the rotation speed of a tool received in the tool holder is adjustable in a range from 300 to 20,000 revolutions per minute.

4. The apparatus according to claim 1, wherein the tool holder is designed to receive a tool selected from a group consisting of a milling cutter, a saw, a grinding wheel, and a polishing wheel.

5. The apparatus according to claim 4, wherein the tool holder includes a clamping apparatus.

6. The apparatus according to claim 1, wherein the specimen holder is pivotable about a pivot axis into a specimen processing position in which a longitudinal axis of the specimen holder is substantially parallel to the longitudinal axis of the tool holder.

7. The apparatus according to claim 1, wherein the observation device includes a measurement device for measuring the specimen.

8. The apparatus according to claim 1, wherein the specimen holder is rotatable about its longitudinal axis.

9. The apparatus according to claim 1, wherein the tool holder is pivotable in a plane normal to its longitudinal axis.

10. The apparatus according to claim 1, further comprising a pump system and a metering tube connected to the pump system for delivering coolant and/or lubricant to the specimen during processing.
